(19) United States
(12) Patent Application Publication
(10) Pub. No.: US 2026/0315848 A1
(43) Pub. Date: Oct. 15, 2026

(54) EXTINGUISHING APPARATUS AND A METHOD FOR USING AN EXTINGUISHING APPARATUS

(71) Applicant: Jarno HAPPONEN, Vantaa (FI)

(72) Inventor: Jarno HAPPONEN, Vantaa (FI)

(21) Appl. No.: 19/101,166

(22) PCT Filed: Aug. 4, 2023
(86) PCT No.: PCT/FI2023/050454

§ 371 Date: Feb. 4, 2025

(30) Foreign Application Priority Data
Aug. 5, 2022 (FI) 20225705

(51) Int. Cl. A62C 31/22

(52) U.S. Cl. CPC A62C 31/22

(57) ABSTRACT

The invention relates to an extinguishing apparatus (1). In order to obtain a solution that is easy to install and does not need to be connected to an external system, the extinguishing apparatus comprises an extinguishing fluid source (2), an outlet (3) for supplying the extinguishing fluid from the extinguishing apparatus (1), a piercer (4) arranged movably to the extinguishing apparatus (1), and a fastening arrangement (5) for fastening the extinguishing apparatus (1) on a surface (6). In response to the triggering of the extinguishing apparatus, the extinguishing apparatus (1) is arranged to move the piercer (4) for bringing it into contact with the surface (6) and to create an opening to the surface (6) for conveying the extinguishing fluid from the outlet (3).

### FIELD OF THE INVENTION

This invention relates to an extinguishing apparatus which comprises a source of extinguishing fluid, an outlet for supplying the extinguishing fluid, a movable piercer, and a fastening arrangement for fastening the extinguishing apparatus on a surface.

### DESCRIPTION OF THE PRIOR ART

In various enclosed spaces, e.g. spaces for transporting and storing goods, it is known to use various automated extinguishing systems to restrain or extinguish fires being caught. These known extinguishing systems are typically based on supplying an extinguishing agent, such as water, to the space in question through a nozzle system arranged inside it. In these cases, the extinguishing system is typically connected to a larger system outside the space for e.g. supplying the extinguishing agent or electric current to the extinguishing system required for the operation of the extinguishing system.

Due to these characteristics, the problem with said extinguishing systems is the laborious installation method required, whereby e.g. various through holes must often be made in the targeted space in order to connect the extinguishing system to the external system. On the other hand, such extinguishing systems also require a constant connection to the external system in order to function. For these reasons, these known extinguishing systems are particularly unsuitable for fire-extinguishing in spaces intended to be mobile, such as shipping containers used for transporting goods, in which case connecting the extinguishing system to the external system or making through holes or other alterations inside the space is not possible. In these cases, even passing to the target space is often not possible.

### SUMMARY OF THE INVENTION

The purpose of this invention is to solve the aforementioned problems and to provide an extinguishing apparatus that enables fire protection in enclosed spaces without laborious installation steps or connection with systems outside the extinguishing apparatus. This object is achieved with an extinguishing apparatus according to independent claim 1, and a method according to independent claim 15.

By constructing the extinguishing apparatus to be surface-mounted and further comprising a source of extinguishing fluid, an outlet for supplying the extinguishing fluid from the extinguishing apparatus and a movably arranged piercer, an easy-to-install extinguishing apparatus that works without external systems or modifications to the target space is achieved.

### BRIEF DESCRIPTION OF THE FIGURES

In the following, the invention is described in more detail by way of example and with reference to the accompanying figures, in which:

FIG. 1 shows a diagonal top view of a surface-mounted extinguishing apparatus,

FIG. 2 shows a direct side view of the cross-section of a piercer arm of the extinguishing apparatus of FIG. 1,

FIG. 3 shows a second embodiment of a surface-mounted extinguishing apparatus,

FIG. 4 shows a third embodiment of a surface-mounted extinguishing apparatus, and

FIG. 5 shows a fourth embodiment of a surface-mounted extinguishing apparatus.

### DESCRIPTION OF AT LEAST ONE EMBODIMENT

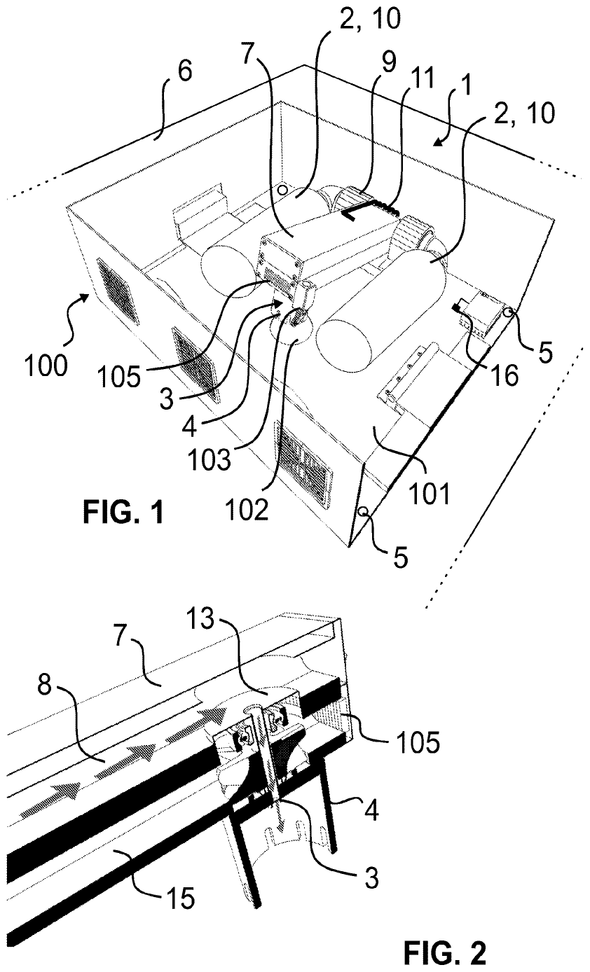

The example of FIG. 1 shows an extinguishing apparatus 1 in a position corresponding to one of its possible installation setups. In the figure, the orientation of the extinguishing apparatus and its fastening surface 6 has been selected only to present the structure of the extinguishing apparatus as clearly as possible and, thus, the representation of the figure does not attempt to describe their actual orientation in the operating mode. In the representation of FIG. 1, some parts that are not critical or not necessary to the operation of the equipment, such as a cover part possibly connected to the extinguishing apparatus and one wall section, have also been omitted for the sake of clarity. The fastening surface 6 is also only partially shown in the figure and designated by dotted lines to indicate the continuity of its outer edges beyond the figure.

The extinguishing apparatus in accordance with said example comprises an extinguishing fluid source 2, an outlet 3 for supplying the extinguishing fluid from the extinguishing apparatus, and a piercer 4 movably arranged in the extinguishing apparatus 1. In the example, the parts in question are arranged inside a body 100 consisting of interconnected walls that define the outer surfaces of the extinguishing apparatus. Thereby, the extinguishing apparatus 1 is arranged to be installed in its location of use such that a bottom wall 101 of the body is positioned against the surface 6, and an opening 102 is arranged in the bottom wall, through which, the surface 6 is in contact with the inner part of the extinguishing apparatus defined by the body 100. The surface 6 in question is a preferably vertical surface included in the location of use of the extinguishing apparatus, which delimits the space to which the extinguishing fluid is supplied by the extinguishing apparatus.

The extinguishing apparatus shown in the example of FIG. 1 further comprises a fastening arrangement 5 for fastening the extinguishing apparatus 1 on the surface 6. Depending on the application of the extinguishing apparatus, the fastening arrangement may include e.g. one or more magnetic elements placed in the body 100 of the extinguishing apparatus, whereby the extinguishing apparatus can be easily and quickly fastened on a surface 6 made of a ferromagnetic material. When arranged in this way, the fastening arrangement 5 is particularly suitable for use in connection with e.g. sea containers. In other embodiments of the extinguishing apparatus, the fastening arrangement 5 may also include some other arrangement instead of or in addition to magnetic elements, such as means to fasten the extinguishing apparatus 1 with separate fastening parts, such as screws.

In the solution shown in FIG. 1, the extinguishing apparatus 1 is arranged in response to its triggering to move the piercer 4 to bring it into contact with the surface 6, and to rotate the piercer to create an opening to the surface 6. The opening in question is thereby intended to be provided by the motion of the piercer 4 according to said description for conveying the extinguishing fluid to be supplied from the outlet 3. The piercer 4 is thus favourably shaped in a way that it works like a drill bit. Then, the extinguishing fluid can be supplied through the created opening inside the space delimited by the surface 6 in order to extinguish or restrain a fire or any sharp increase in temperature observed in the space. More specifically, in the example in question, a movable piercer arm 7 is arranged in the extinguishing apparatus 1 for moving the piercer 4, whereby the piercer 4 extends from the piercer arm. At the end of the piercer arm farther from the piercer 4, a joint 9 is provided to connect the piercer arm 7 to the extinguishing apparatus 1. In this case, the piercer arm 7 is arranged in the extinguishing apparatus to be moved through the joint 9, whereby the motion of the piercer arm simultaneously provides the motion of the piercer 4. The piercer 4 is then preferably arranged close to the free end of the piercer arm 7.

More specifically, in the example of FIG. 1, the piercer 4 is arranged to be movable by the rotation of the piercer arm 7, and the joint 9 acts as the axis of rotation of the piercer arm 7. However, in some embodiments of the extinguishing apparatus, the motion of the piercer 4 may also be implemented in some other way than by means of the piercer arm 7, whereby the motion of the piercer may be based e.g. on a force pushing it towards the surface 6 in a rectilinear motion, such as spring force or pneumatic force.

The extinguishing apparatus 1 in accordance with the example of FIG. 1 is arranged to supply extinguishing fluid from the extinguishing fluid source 2 in response to triggering of the extinguishing fluid supply. The extinguishing fluid supply in question may then be arranged to be triggered as a result of one or more events detected by the extinguishing apparatus 1, which may be internal or external events of the extinguishing apparatus. In one preferable embodiment of the extinguishing apparatus, the extinguishing apparatus 1 is arranged to trigger the extinguishing fluid supply in response to the moving of the piercer arm 7 to a predetermined position. Thereby, said predetermined position of the piercer arm 7 preferably corresponds to a position close to one extreme of the range of motion of the piercer arm, which the piercer arm reaches after piercing the surface 6 as a result of the triggering of the extinguishing apparatus 1. In other words, the extinguishing fluid supply is thereby arranged to be triggered at the point when an opening has been created to the surface 6 as a result of the rotation of the piercer 4 against the surface, whereby the piercer arm 7, as a result of the creation of the opening, moves beyond a predetermined limit towards the surface 6.

This predetermined position of the piercer arm 7 may be, for example, a certain angular position of the piercer arm in relation to the other parts of the extinguishing apparatus 1, or even a position defined by a point reached by the free end of the piercer arm 7. Then, the triggering of the extinguishing fluid supply can be implemented by a trigger 103, which can be a mechanical trigger, as shown in the example of FIG. 1, or an electrical trigger. In this case, the electrical current required by the electrical trigger may originate e.g. from a power source or a thermoelectric generator element arranged in connection with the extinguishing apparatus. Said sources of electric current may also be included e.g. in a fire detector arranged in connection with the extinguishing apparatus. If the trigger 103 is a mechanical trigger, it can be, as shown in the example of FIG. 1, arranged to the piercer arm 7 close to the piercer 4, whereby the triggering of the extinguishing fluid supply may occur when the trigger comes into contact with the surface 6 or the bottom wall 101 of the extinguishing apparatus. Alternatively, the triggering of the extinguishing fluid supply can also be arranged to occur on the basis of e.g. measurable data transmitted through the opening created to the surface 6, such as temperature data of the space delimited by the surface.

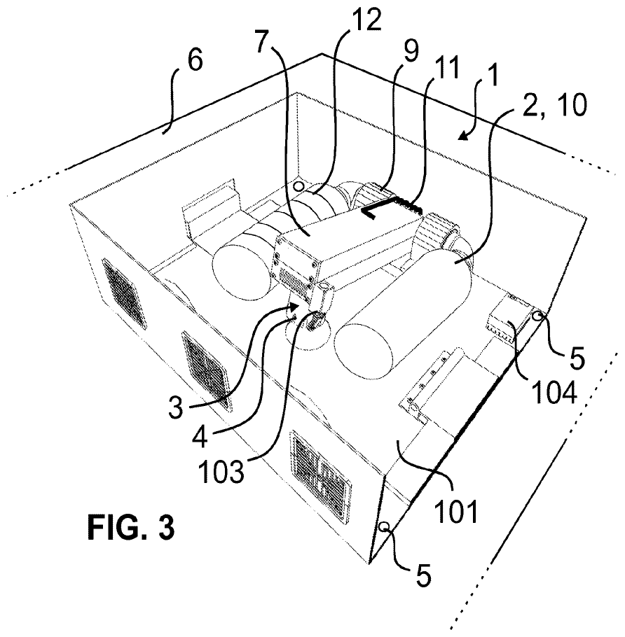

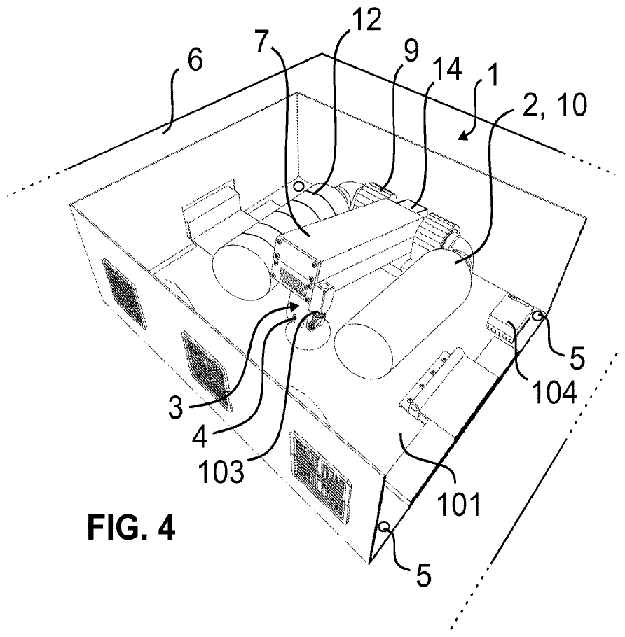

The example of FIG. 2 shows a cross-section of the piercer arm 7 of the extinguishing apparatus of FIG. 1 in an area of the end of the piercer arm closer to the piercer 4. The structure of the piercer arm 7 shown in FIG. 2 also corresponds to the structure of the piercer arm of the embodiments of the extinguishing apparatus described later and shown in FIGS. 3 and 4. In the example in question, the outlet 3 is arranged to the piercer arm 7, and the piercer 4 extends from the piercer arm 7 around the outlet 3 in its opening direction. That is, the shape of the piercer 4, as shown in the example of FIGS. 1 and 2, is arranged to be circular, whereby the piercer defines a space in its centre into which the outlet 3 opens. Thereby, the diameter of the outer circumference of the piercer 4 simultaneously defines the diameter of the opening to be made on the surface 6. Said arrangement enables an automatic positioning of the outlet 3 to a preferable position for supplying the extinguishing fluid through the opening created to the surface 6. More specifically, when the outlet 3 is arranged to a position and orientation corresponding to the position and orientation of the piercer 4, the outlet 3 can be directed without additional steps towards the openings created to the surface 6 by the piercer 4. Then, the piercer 4 can additionally act as an element controlling the supply of extinguishing fluid through the opening created in the surface 6, whereby the walls of the piercer extending from the piercer arm 7 form a tubular structure between the outlet 3 and the opening.

In the example of FIGS. 1 and 2, the piercer arm 7 is arranged in connection with the extinguishing fluid source 2 and comprises a channel 8 for transmitting the extinguishing fluid from the extinguishing fluid source 2 to the outlet 3. More specifically, in the example in question, the piercer arm is in connection with the extinguishing fluid source via the joint 9, whereby the channel 8 extends through the joint and then further along the piercer arm 7 to the outlet 3. The direction of the fluid flow inside the channel 8 is shown by the arrow markings in FIG. 2. In said example, the extinguishing fluid source comprises two pressured containers 10 for storing extinguishing fluid, whereby the extinguishing fluid contained in them is preferably pressurized gas, liquid or aerosol. Then, the extinguishing fluid can be arranged to pass along a channel 8 from the extinguishing fluid source 2 to the outlet 3 by means of its own fluid pressure, whereby the supply of the extinguishing fluid can be controlled e.g. by means of a valve system connected to the extinguishing fluid source 2 or the channel 8. Alternatively, the extinguishing fluid may comprise high-pressure gas or aerosol-forming fluid e.g. as a result of a combustion reaction triggered in connection with the triggering of the extinguishing fluid supply. In the arrangement in accordance with the example of FIG. 1, the pressured containers 10 are arranged on both sides of the piercer arm 7, whereby they connect with the joint 9 symmetrically on its different sides.

In other embodiments of the extinguishing apparatus, the extinguishing fluid source 2 may also be arranged in a manner different from the example of FIG. 1, whereby it may include e.g. a space for storing extinguishing media in solid form. In such a case, the solid extinguishing agent in question may also be converted into fluid form e.g. as a result of a combustion reaction triggered in connection with the triggering of the extinguishing fluid supply, for generating and supplying the extinguishing fluid from the extinguishing fluid source 2. When the extinguishing fluid is stored directly in fluid form, the number of the pressured containers 10 of the extinguishing fluid source may also differ from the example of FIG. 1, whereby there is preferably at least one of them. In applications where it is possible to connect the extinguishing apparatus 1 to external systems, the extinguishing fluid source 2 may also comprise a fixedly arranged extinguishing fluid supply to the extinguishing apparatus 1 from outside of it.

In the example of FIGS. 1 and 2, the rotational motion of the piercer 4 is arranged by means of a pneumatic apparatus 13 arranged to the piercer arm 7 and operating by fluid pressure. The pneumatic apparatus may comprise e.g. a turbine as shown in the example in question, whereby the flow of pressurised fluid entering the pneumatic apparatus 13 causes the rotational motion of the turbine and, at the same time, the rotational motion of the piercer 4 connected to the pneumatic apparatus in relation to their common central axis. In this case, it is possible to use e.g. the extinguishing fluid of the extinguishing fluid source 2 in accordance with the example of FIGS. 1 and 2 as the drive fluid transmitting the drive force to the pneumatic apparatus in question, whereby the extinguishing fluid source 2 also acts as the drive fluid source. Then, a second channel 15 is provided to the piercer arm 7 for the extinguishing fluid flowing to the piercer 4 for receiving and delivering the extinguishing fluid to the pneumatic apparatus 13. In the example of FIG. 2, a passage has also been arranged to the pneumatic apparatus at its central axis to allow passing of the extinguishing fluid to the outlet 3. The example of FIG. 3 shows a second embodiment of the extinguishing apparatus, wherein the extinguishing apparatus 1 comprises a separate drive fluid source 12, whereby the rotation of the piercer 4 takes place by means of the fluid pressure of the drive fluid obtained from the drive fluid source in question. In this case, the composition, state and properties of the drive fluid may correspond to or differ from those of the extinguishing fluid, whereby e.g. the pressure of the drive fluid arriving at the pneumatic apparatus 13 may be arranged to be higher or lower than the pressure of the extinguishing fluid.

In the example of FIGS. 1-3, the motion of the piercer arm 7 is arranged by means of a trigger spring 11 arranged to it. Then, when the extinguishing apparatus 1 is ready to be triggered, the trigger spring 11 is preferably arranged in a tensioned position, whereby the triggering of the extinguishing apparatus causes the tensioning to unwind and thus the motion of the piercer arm 7 by means of the spring force of the trigger spring 11. In this case, the spring force in question also produces a force pressing the piercer 4 against the surface 6 after the free motion of the piercer arm 7. The arrangement of the trigger spring 11 to the piercer arm 7 in this context means that the trigger spring is arranged in contact with it in order to transmit the spring force to the piercer arm. The triggering of the trigger spring 11 can take place e.g. by means of a simple mechanical latch arrangement, whereby the release of the latch in connection with the triggering of the extinguishing apparatus releases the motion of the trigger spring 11. In this case, the latch arrangement in question may be arranged e.g. in connection with the joint 9, whereby it prevents the motion of the surfaces pivotedly attached to each other in relation to each other when the extinguishing apparatus is ready for use. Then, the latch arrangement can be arranged to be released e.g. by means of the fluid pressure of the extinguishing or drive fluid when the extinguishing apparatus is triggered.

The example of FIG. 4 shows a third embodiment of the extinguishing apparatus, which comprises an alternative arrangement to the example of FIGS. 1-3 for arranging the motion of the piercer arm 7. In the example in question, the extinguishing apparatus 1 comprises, equivalent to the example of FIG. 3, a drive fluid source 12, and a second pneumatic apparatus 14 is arranged to the piercer arm. Then, the piercer arm 7 is moved by the second pneumatic apparatus by means of the fluid pressure of the drive fluid. The arrangement of the second pneumatic apparatus 14 to the piercer arm 7 in this context means that the second pneumatic apparatus is arranged in contact with it in order to transmit the force transmitted by fluid pressure further to the piercer arm. The triggering of the second pneumatic apparatus 14 can take place e.g. by controlling the run of the drive fluid, whereby the pressure of the drive fluid automatically causes the motion of the piercer arm 7 when the drive fluid arrives at the pneumatic apparatus 14. The second pneumatic apparatus 14 may, in some embodiments of the extinguishing apparatus, also be arranged to operate by means of the fluid pressure of the extinguishing fluid, whereby a separate drive fluid source is not required.

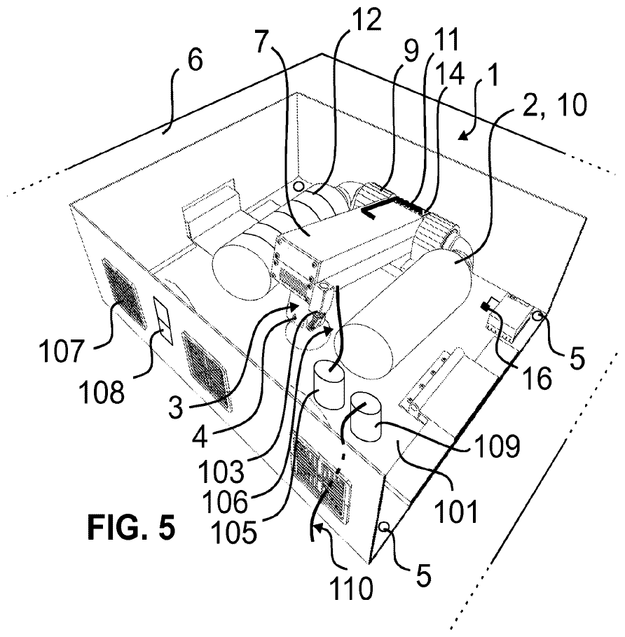

The example of FIG. 5 shows a fourth embodiment of the extinguishing apparatus, which comprises an alternative arrangement to the example of FIGS. 1-4 for arranging the motion of the piercer arm 7. In the embodiment of the extinguishing apparatus in question, the trigger spring 11 and the second pneumatic apparatus 14 are arranged to the apparatus simultaneously. In this case, they may be brought together to co-operate e.g. by the trigger spring 11 producing a spring force that presses the piercer 4 against the surface 6 as described above, and the second pneumatic apparatus 14 producing a pulsed force pushing the piercer arm 7 in the opposite direction. The arrangement in question thus makes it possible to bring the piercer 4 into a repeated impact motion against the surface 6, whereby the motion of the piercer towards the surface 6 occurs between the force pulses produced by the second pneumatic apparatus 14, and the motion in the opposite direction occurs during the force pulses. The arrangement in question allows an opening to be created in the surface 6 utilising this impact motion, whereby the impact motion can be used to create the opening, either in combination with the rotation of the piercer 4 or as the only mechanism breaking the surface 6. That is, in this case, in response to the triggering of the extinguishing apparatus, the extinguishing apparatus 1 is arranged to perform at least one of the rotation of the piercer 4 and bringing the piercer into an impact motion against the surface 6 in order to create the opening to the surface 6.

In addition, the example of FIG. 5 shows an arrangement wherein the extinguishing apparatus 1 further comprises a second trigger 105 for triggering the fluid supply as a result of mechanical activation or some other impulse. In the example in question, the second trigger 105 is arranged to connect to the piercer arm 7 close to its free end via a wire 106, whereby the triggering of the fluid supply can be set to occur e.g. when the piercer arm 7 moves close to the extreme of its range of motion as a result of the piercing of the surface 6. More specifically, in said position of the piercer arm 7, the piercer arm causes the wire 106 to tension and thus the activation of the second trigger 105 to trigger the fluid supply. The arrangement in question can be used in the extinguishing apparatus instead of the trigger 103 as the only mechanism to trigger the fluid supply, or in combination with the trigger 103, corresponding the example of FIG. 5. When the extinguishing apparatus comprises the trigger 103 and the second trigger 105 simultaneously, the triggering of the fluid supply can be set to take place e.g. only after both triggers have been activated, in order to verify the desired operation of the fluid supply.

The second trigger 105, as shown in the example of FIG. 5, can also be used e.g. to trigger the fluid supply without activating the piercer arm 7, i.e. without performing the triggering of the extinguishing apparatus described above. More specifically, in this case, the fluid supply can be triggered by activating the second trigger 105 to supply the extinguishing fluid from the outlet 3 to the space where the extinguishing apparatus 1 is currently located. Then, the extinguishing fluid can be channelled to the space in question e.g. through exits 107 arranged to the walls of the body 100. In this case, the activation of the second trigger 105 can take place e.g. on the basis of the measured temperature value of the space, whereby a detector arranged either in the space or directly in connection with the extinguishing apparatus 1 can be used to measure the temperature. The arrangement according to the description enables the use of the extinguishing apparatus 1 also for extinguishing fires occurring e.g. in the location of the apparatus, whereby the same apparatus works for fire protection from outside of the enclosed space as a result of the triggering of the extinguishing apparatus 1 on one hand, and on the other hand, at the installation location of the apparatus as a result of the triggering of the extinguishing fluid supply alone. In the example of FIG. 5, the extinguishing apparatus also comprises a switch 108, through which the desired mode of operation of the second trigger 105 can be selected between the mechanical activation and the temperature-based activation described above.

Furthermore, the example of FIG. 5 additionally shows an arrangement for the manual triggering of the extinguishing apparatus 1. In the example in question, the arrangement is implemented by means of a third trigger 109, which is arranged to be activated via a trigger cable 110 in connection with the external space of the extinguishing apparatus 1. More specifically, in the example in question, the activation of the third trigger 109, and thus the triggering of the extinguishing apparatus 1, occurs as a result of tensioning of the trigger cable 110 e.g. when pulling the trigger cable. The arrangement in question enables the use of the extinguishing apparatus 1, on one hand, as described above, as part of an automated fire protection system and, on the other hand, as a manual extinguishing apparatus. Said second 105 and third trigger 109 may include e.g. a TAG trigger.

In the example of FIGS. 3, 4 and 5, the piercer arm 7 is arranged in connection with a drive fluid source 12 and comprises a second channel 15 for receiving drive fluid from the drive fluid source 12. The second channel 15 in question is then arranged for the transmission of the drive fluid from the drive fluid source 12 to the pneumatic apparatus or apparatuses 13, 14 using it in each embodiment. In the example of FIGS. 1 and 2, where the extinguishing fluid of the extinguishing fluid source 2 acts as the drive fluid, the second channel 15 is arranged correspondingly for receiving the extinguishing fluid from the extinguishing fluid source 2 and for transmitting it to the pneumatic apparatus 13. Both in the situation where the drive fluid source 12 is the extinguishing fluid source 2 and in the situation where the extinguishing apparatus 1 comprises the separate drive fluid source 12, the supply of the drive fluid can be controlled e.g. by means of a second valve system connected to the drive fluid source 12 or to the second channel 15, whereby the supply of the drive fluid can be arranged to occur e.g. as an immediate response to the triggering of the extinguishing apparatus 1. In some embodiments of the extinguishing apparatus, the moving of the piercer arm 7 and the rotating of the piercer 4 may also be arranged to occur at different times, e.g. as a timed response to the triggering of the extinguishing apparatus 1. In the examples of FIGS. 1-4, an exit 105 is additionally arranged to the piercer arm for removing from the piercer arm the drive fluid that has by-passed the pneumatic apparatus 13.

In the examples of FIGS. 1 and 5, a signal input 16 is additionally provided to the extinguishing apparatus 1 for receiving the trigger signal of the extinguishing apparatus. The signal input in question may include e.g. an electrical signal receiver for receiving a trigger signal transmitted wirelessly or by means of a data cable. Thereby, the electrical signal in question may originate e.g. directly from a fire detector arranged in the space delimited by the fastening surface 6 of the extinguishing apparatus or in the location of the extinguishing apparatus, or possibly from a control unit controlling a larger entity consisting of numerous fire detectors and extinguishing apparatuses 1. In some embodiments of the fire detector, a non-electrical signal, such as a thermal signal transmitted by a fuse or a filament, may also act as the trigger signal. In some embodiments of the extinguishing apparatus, the fire detector 104 may also be arranged directly as part of the structure of the extinguishing apparatus, as shown in the examples of FIGS. 3 and 4, whereby it may include e.g. a sensor observing the rise in temperature of the surface 6.

In a method corresponding to the preferable use of the extinguishing apparatus as shown in the examples of FIGS. 1-4, the extinguishing apparatus 1 is fastened on the surface 6. The surface 6 in question is then preferably a vertical surface included in the location of use of the extinguishing apparatus, which delimits the space where the extinguishing fluid of the extinguishing apparatus is supplied. Subsequently, depending on the type of the trigger signal used in the current operating situation and the location of the fire detector, the extinguishing apparatus may be immediately ready to receive the trigger signal. Alternatively, the extinguishing apparatus 1 can be connected for receiving an electrical signal or e.g. a thermal signal, e.g. to a fire detector or a control unit by means of a conductor intended for transmitting these signals. Regardless of the type of trigger signal, its reception to the extinguishing apparatus 1 e.g. as a result of a fire detected in the space where the extinguishing fluid is supplied, causes the motion of the piercer 4 into contact with the surface 6. Simultaneously with said movement of the piercer 4, or, alternatively, after this, the rotation of the piercer 4 begins for creating an opening to the surface 6. When said opening has been created by the motion according to the description, extinguishing fluid is supplied into it by the extinguishing apparatus. More specifically, the extinguishing apparatus 1 is then arranged to supply the extinguishing fluid through the opening to the space targeted for the supply, in order to extinguish or limit a fire detected in said space. All method steps in accordance with the description may be carried out with the extinguishing apparatus using the above-mentioned structural elements of the extinguishing apparatus.

For example, pressurised fluid, such as NOVEC 1230 fire extinguishing agent, or inert gas, such as argon, may be used as the extinguishing fluid in the extinguishing apparatus in accordance with the description. Alternatively, fire extinguishing agent in a solid or condensed form, such as Stat-X aerosol, can be used in the extinguishing apparatus, whereby the extinguishing fluid required for the operation of the extinguishing apparatus is produced as a result of a combustion reaction of said extinguishing agent. In those embodiments of the extinguishing apparatus that comprise a separate source of drive fluid for moving the parts of the extinguishing apparatus in accordance with the previous description, gases generated by the combustion reaction of various solid reactive substances, such as gunpowder or magnesium powder, may be used as drive fluids in addition to the above-mentioned substances acting as extinguishing fluids. Then, e.g. aqueous film forming foam fluid can also be used as the extinguishing fluid.

It is to be understood that the above description and the related figures are only intended to illustrate the present invention. It will be obvious to those skilled in the art that the invention may also be varied and modified in other ways without departing from the scope of the invention.

1. An extinguishing apparatus comprising a body defining outer surfaces of the extinguishing apparatus, the extinguishing apparatus further comprising, arranged inside the body:
an extinguishing fluid source,
a joint connected to the body,
a piercer arm connecting to the body of the extinguishing apparatus rotatably through the joint, wherein the joint is provided at the end of the piercer arm farther from a piercer and the joint acts as an axis of rotation of the piercer arm,
the piercer, extending from the piercer arm and arranged to be movable by means of rotation of the piercer arm through the joint,
an outlet arranged to the piercer arm for supplying extinguishing fluid from the extinguishing apparatus, wherein the piercer extends from the piercer arm around the outlet in its opening direction and the shape of the piercer is arranged to be circular, whereby the piercer defines a space in its centre into which the outlet opens,
whereby the piercer arm is arranged in connection with the extinguishing fluid source via the joint and comprises a channel for transmitting the extinguishing fluid from the extinguishing fluid source to the outlet, whereby the channel extends through the joint and then further along the piercer arm to the outlet, and
a fastening arrangement arranged to the body for fastening the extinguishing apparatus on a surface, wherein
in response to triggering of the extinguishing apparatus, the extinguishing apparatus is arranged to rotate the piercer arm to move the piercer for bringing it into contact with the surface and to create an opening to the surface for conveying extinguishing fluid supplied from the outlet.

2. The extinguishing apparatus according to claim 1, wherein, in response to the triggering of the extinguishing apparatus, the extinguishing apparatus is arranged to rotate the piercer for creating the opening to the surface.

3. The extinguishing apparatus according to claim 1, wherein, in response to the triggering of the extinguishing apparatus, the extinguishing apparatus is arranged to bring the piercer to an impact motion against the surface for creating the opening to the surface.

4. The extinguishing apparatus according to claim 1, wherein the extinguishing apparatus further comprises a trigger for triggering the extinguishing fluid supply, whereby the extinguishing apparatus is arranged to supply the extinguishing fluid of the extinguishing fluid source in response to triggering of the extinguishing fluid supply.

5. The extinguishing apparatus according to claim 4 wherein the trigger is arranged to trigger the extinguishing fluid supply in response to moving of the piercer arm to a predetermined position.

6. The extinguishing apparatus according to claim 1, wherein the extinguishing fluid source comprises at least one pressured container for storing the extinguishing fluid.

7. The extinguishing apparatus according to claim 1, wherein the extinguishing apparatus further comprises a drive fluid source, and the piercer arm comprises a pneumatic apparatus for rotating the piercer by means of fluid pressure of the drive fluid.

8. The extinguishing apparatus according to claim 1, wherein trigger spring is arranged to the piercer arm for moving the piercer by means of spring force of the trigger spring.

9. The extinguishing apparatus according to claim 1, wherein the extinguishing apparatus further comprises a drive fluid source, and a second pneumatic apparatus is arranged to the piercer arm for moving the piercer arm by means of fluid pressure of the drive fluid.

10. The extinguishing apparatus according to claim 7, wherein the piercer arm is arranged in connection with the drive fluid source and comprises a second channel for receiving drive fluid from the drive fluid source.

11. The extinguishing apparatus according to claim 1, wherein a signal input is arranged to the extinguishing apparatus for receiving the trigger signal of the extinguishing apparatus.

12. A method for using an extinguishing apparatus according to claim 1, the method comprising:
fastening the extinguishing apparatus on a surface,
receiving a trigger signal to the extinguishing apparatus,
moving a piercer into contact with the surface by rotating a piercer arm through a joint,
rotating the piercer for creating an opening to the surface, and
supplying extinguishing fluid to the opening by the extinguishing apparatus.
